(19) United States
(12) Patent Application Publication
(10) Pub. No.: US 2026/0259643 A1
(43) Pub. Date: Sep. 3, 2026

(54) INTERACTION OPERATION PROCESSING METHOD, APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventor: Gao LIU, Beijing (CN)

(21) Appl. No.: 19/539,739

(22) Filed: Feb. 13, 2026

(30) Foreign Application Priority Data
Mar. 3, 2025 (CN) 202510246145.8

(51) Int. Cl. G06F 3/0484; G06F 3/0481; G06F 3/0482; G06F 9/451

(52) U.S. Cl. CPC G06F 3/0484; G06F 3/0481; G06F 3/0482; G06F 9/451

(57) ABSTRACT

Embodiments of the present disclosure provide an interaction operation processing method, an apparatus, an electronic device, a storage medium, and a program product. The method includes: receiving multiple interaction operations through an interaction interface, and determining an execution order of the multiple interaction operations and a first node corresponding to the interaction operation; connecting multiple first nodes according to the execution order of the multiple interaction operations to obtain at least one directed operation graph; and executing first processing logics corresponding to the multiple first nodes according to the directed operation graph to obtain target media data, and displaying the target media data in the interaction interface.

### CROSS-REFERENCE TO RELATED APPLICATION(S)

This application claims priority to Chinese Application No. 202510246145.8 filed March 3, 2025, the disclosure of which is incorporated herein by reference in its entirety.

### TECHNICAL FIELD

Embodiments of the present disclosure relate to the field of computer processing technologies and, in particular, to an interaction operation processing method, an apparatus, an electronic device, a storage medium, and a program product.

### BACKGROUND

With the rapid development of computer technologies, the forms of media content have become increasingly rich and diverse, and users' processing requirements for multimedia content have also become increasingly complex and dynamic. To meet these requirements for in-depth editing and creation, multiple interaction operations usually need to be performed to process media data.

In the related art, developers usually write logic code for the response logic of each interaction operation. The logic code between each of the interaction operations is often closely related and dependent.

### SUMMARY

The present disclosure provides an interaction operation processing method, an apparatus, an electronic device, a storage medium, and a program product to solve the technical problem of code redundancy in the processing and development of media data by interaction operations.

In a first aspect, an embodiment of the present disclosure provides an interaction operation processing method, including:

receiving multiple interaction operations through an interaction interface, and determining an execution order of the multiple interaction operations and a first node corresponding to the interaction operation;

connecting multiple first nodes according to the execution order of the multiple interaction operations to obtain at least one directed operation graph; and

executing first processing logics corresponding to the multiple first nodes according to the directed operation graph to obtain target media data, and displaying the target media data in the interaction interface.

In a second aspect, an embodiment of the present disclosure further provides an interaction operation processing apparatus, including:

an interaction operation receiving module configured to receive multiple interaction operations through an interaction interface, and determine an execution order of the multiple interaction operations and a first node corresponding to the interaction operation;

an operation graph construction module configured to connect multiple first nodes according to the execution order of the multiple interaction operations to obtain at least one directed operation graph; and

an interaction result display module configured to execute first processing logics corresponding to the multiple first nodes according to the directed operation graph to obtain target media data, and display the target media data in the interaction interface.

In a third aspect, an embodiment of the present disclosure further provides an electronic device, including:

one or more processors,

a storage apparatus configured to store one or more programs,

when the one or more programs are executed by the one or more processors, the one or more processors are caused to implement the interaction operation processing method according to any one of the embodiments of the present disclosure.

In a fourth aspect, an embodiment of the present disclosure further provides a storage medium including computer-executable instructions, and when the computer-executable instructions are executed by a computer processor, the interaction operation processing method according to any one of the embodiments of the present disclosure is performed.

In a fifth aspect, an embodiment of the present disclosure further provides a computer program product, including a computer program, and when the computer program is executed by a processor, the interaction operation processing method according to any one of the embodiments of the present disclosure is implemented.

In the technical solution of the embodiment of the present disclosure, multiple interaction operations are received through an interaction interface, an execution order of the multiple interaction operations and a first node corresponding to the interaction operation are determined, and the interaction interface is provided to facilitate the user to flexibly process media data through the multiple interaction operations, which enriches the processing manners of the media data. The execution order of the multiple interaction operations is determined to map the interaction manners into operation response logic, map the operation response logic into the first node, and achieve decoupling of the interaction operations and the processing logic by the first node. Furthermore, multiple first nodes are connected according to the execution order of the multiple interaction operations to obtain at least one directed operation graph, to clearly represent the response logic to the multiple interaction operations by the directed connection between the nodes in the directed operation graph. Moreover, the execution order of the multiple interaction operations may be indicated by the connection manner of the nodes in the directed operation graph. The first processing logics corresponding to the multiple first nodes are executed according to the directed operation graph to obtain the target media data, and the target media data is displayed in the interaction interface, the execution logic of the first processing logics may be determined by the connection manner of the first node, the first node is mapped to the first processing logic, and the target media data is obtained by executing the first processing logic, to achieve the quick response to the multiple interaction operations, solve the technical problem of code redundancy in the processing and development of media data by interaction operations in the related art, achieve decoupling of the interaction operations and the operation response logic by the nodes in the directed operation graph.

### BRIEF DESCRIPTION OF THE DRAWINGS

In combination with the drawings and with reference to the following specific embodiments, the above-mentioned and other features, advantages, and aspects of various embodiments of the present disclosure will become more apparent. Throughout the drawings, the same or similar reference symbols refer to the same or similar elements. It should be understood that the drawings are schematic and that parts and elements are not necessarily drawn to scale.

FIG. 1 is a schematic flowchart of an interaction operation processing method provided by an embodiment of the present disclosure;

FIG. 2 is a schematic flowchart of another interaction operation processing method provided by an embodiment of the present disclosure;

FIG. 3 is a schematic flowchart of another interaction operation processing method provided by an embodiment of the present disclosure;

FIG. 4 is an example diagram of a relationship between a component and a node in an interaction operation processing method provided by an embodiment of the present disclosure;

FIG. 5 is a schematic structural diagram of an interaction operation processing apparatus provided by an embodiment of the present disclosure; and

FIG. 6 is a schematic structural diagram of an electronic device used to implement an embodiment of the present disclosure.

### DETAILED DESCRIPTION OF EMBODIMENTS

Embodiments of the present disclosure will be described in more detail below with reference to the drawings. Although certain embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only for exemplary purposes and are not intended to limit the protection scope of the present disclosure.

It should be understood that various steps described in method implementations of the present disclosure may be performed in different orders and/or in parallel. Furthermore, the method implementations may include additional steps and/or omit the execution of the shown steps. The scope of the present disclosure is not limited in this regard.

As used herein, the term "include/comprise" and its variants are open-ended inclusions, that is, "include/comprise but not limited to". The term "based on" is "at least partially based on". The term "an embodiment" means "at least one embodiment"; the term "another embodiment" means "at least one other embodiment"; and the term "some embodiments" means "at least some embodiments". Relevant definitions of other terms will be given in the following description.

It should be noted that concepts such as "first" and "second" mentioned in the present disclosure are only used to distinguish different apparatuses, modules, or units, and are not used to limit the order of functions performed by these apparatuses, modules, or units or interdependence therebetween.

It should be noted that the modifications of "a" and "multiple" mentioned in the present disclosure are illustrative rather than restrictive, and those skilled in the art should understand that unless otherwise clearly indicated in the context, they should be understood as "one or more".

The names of messages or information exchanged between multiple apparatuses in the implementations of the present disclosure are only for illustrative purposes, and are not intended to limit the scope of these messages or information.

It may be understood that before using the technical solutions disclosed in each of the embodiments of the present disclosure, the user should be informed of the type, range of use, use scenarios, etc., of personal information involved in the present disclosure in an appropriate manner and obtain the authorization of the user in accordance with relevant laws and regulations.

For example, in response to receiving an active request from the user, prompt information is sent to the user to clearly prompt the user that the requested operation will require access to and use of the user's personal information. In this way, the user may independently choose whether to provide personal information to software or hardware, such as an electronic device, an application, a server, or a storage medium, that perform the operations of the technical solutions of the present disclosure based on the prompt information.

As an optional but non-limiting implementation, in response to receiving the active request from the user, the manner of sending the prompt information to the user may be, for example, a pop-up window, and the prompt information may be presented in the pop-up window in text. Furthermore, the pop-up window may also carry a selection control for the user to select "agree" or "disagree" to provide the personal information to the electronic device.

It may be understood that the above process of notifying and obtaining user authorization is only illustrative and does not constitute a limitation on the implementations of the present disclosure, and other manners that satisfy the relevant laws and regulations may also be applied to the implementations of the present disclosure.

It may be understood that the data involved in the technical solution (including but not limited to the data itself, acquisition or use of the data) should comply with the requirements of corresponding laws, regulations, and related provisions.

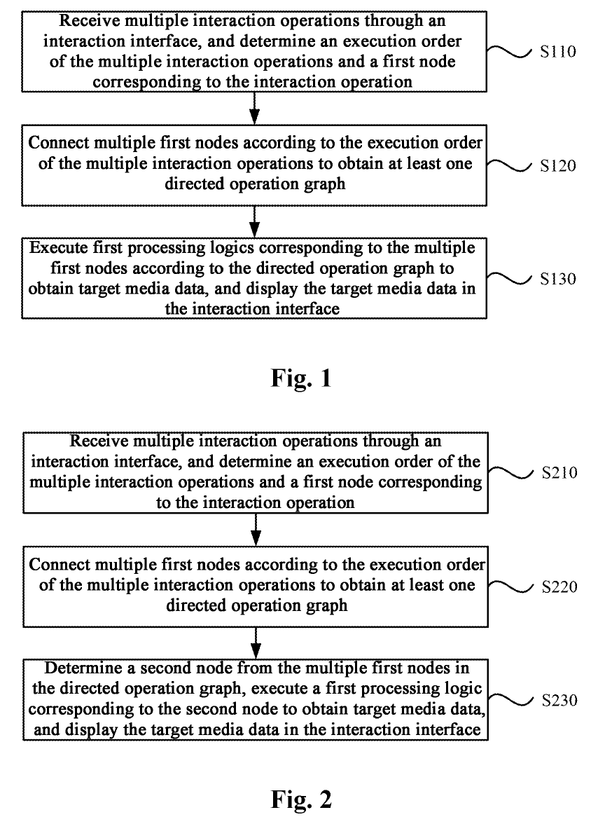

FIG. 1 is a schematic flowchart of an interaction operation processing method provided by an embodiment of the present disclosure. The embodiment of the present disclosure is applicable to a scenario of processing an interaction operation, and the method may be performed by an interaction operation processing apparatus, which may be implemented in the form of software and/or hardware, and optionally, by an electronic device, which may be a mobile terminal, a PC, a server, etc.

In the related art, a high degree of coupling of the logic code between each of the interaction operations exists, resulting in a large amount of code redundancy in the interaction operation response logic. As shown in FIG. 1, the method in this embodiment may specifically include the following steps.

S110: Multiple interaction operations are received through an interaction interface, and an execution order of the multiple interaction operations and a first node corresponding to the interaction operation are determined.

The interaction interface may be used to receive an interaction operation and display target media data obtained after processing the interaction operation. In an embodiment of the present disclosure, the interaction interface may include an effect editing interface and/or a template editing interface. The effect editing interface may be understood as a visual interface supporting effect editing. Optionally, the effect editing interface may include an interface for editing an effect file and/or an interface for editing media content by applying the effect file. The interface for editing the effect file may be used to receive an effect production operation to generate the effect file based on the effect production operation. The interface for editing the media content by applying the effect file may be used to receive an editing operation of the media content to which the effect file is applied, to set the media content to which the effect file is applied. The template editing interface may be an interface that may be used to edit a template file, and the template file may include a data slot for setting media content and preset processing logic corresponding to the media content.

In an embodiment of the present disclosure, the interaction operation may be understood as an operation acting on a preset interaction element on the interaction interface. Taking the interaction interface as the effect editing interface as an example, the interaction operation may be understood as an effect editing operation received through the effect editing interface. Exemplarily, multiple effect editing operations may be an object shooting operation, a filter adding operation, a region detection operation, and a sticker adding operation in sequence. In an embodiment of the present disclosure, the first node may be understood as a node corresponding to the interaction operation. Determining the first node corresponding to the interaction operation includes: when each interaction operation is received, creating a node corresponding to the interaction operation. That is, one first node represents one interaction operation.

In an embodiment of the present disclosure, receiving multiple interaction operations through an interaction interface may include: displaying multiple controls in the interaction interface, and receiving an interaction operation for at least one of the controls through the interaction interface. With the technical solution, the information presented on the interface may be enriched, the interaction manner may be simplified, and the interaction efficiency may be improved.

A response event of the control is associated with a pre-built component. The component may be encapsulated with a second processing logic. That is, in an embodiment of the present disclosure, when the response event of the control is triggered, the pre-built component is called instead of directly interacting with the logic code, which reduces the direct dependence between the control and the component. Furthermore, the encapsulated component may be reused in different controls without rewriting the same processing logic every time, which enhances the code reusability. In an embodiment of the present disclosure, the second processing logic is a function implementation of the component, which is usually included in one or more classes and exists in the form of a method. These methods define specific behaviors of the component, such as data processing and business processing logic execution.

In an embodiment of the present disclosure, determining an execution order of the multiple interaction operations may include: determining an execution order of each of the interaction operations according to a preset interaction rule. The preset interaction rule may include a rule to be followed to determine the execution order of the multiple interaction operations based on trigger information of the interaction operations. In an embodiment of the present disclosure, the trigger information of the interaction operation may be an operation sequence of the operated control. Exemplarily, the interaction interface includes a first control, a second control, and a third control. When the interaction interface receives control trigger operations for the first control, the second control, and the third control in sequence, the execution order of each interaction operation may be the same as the operation sequence of the corresponding operated control.

In an embodiment of the present disclosure, after determining an execution order of each of the interaction operations, the method may further include: displaying operation identifications corresponding to the multiple interaction operations in the interaction interface according to the execution order of each of the interaction operations; and receiving an identification editing operation for at least one of the operation identifications through the interaction interface, and updating the execution order of the multiple interaction operations according to the identification editing operation. In an embodiment of the present disclosure, the identification editing operation for at least one of the operation identifications is supported through the interaction interface, so that the execution order of the interaction operations may be flexibly adjusted intuitively and conveniently.

The operation identification may be used to distinguish different interaction operations. In an embodiment of the present disclosure, the identification editing operation may include at least one of an identification position adjustment operation, an identification adding operation, and an identification deleting operation. The identification position adjustment operation may be understood as an operation for adjusting positions of the operation identifications corresponding to the multiple interaction operations, to adjust the execution order of the interaction operations. The identification adding operation may be understood as an operation for adding an additional operation identification to the operation identifications corresponding to the multiple interaction operations. The identification deleting operation may be understood as an operation for deleting at least one operation identification from the operation identifications corresponding to the multiple interaction operations.

Specifically, the operation identifications corresponding to the multiple interaction operations are displayed in the interaction interface according to the execution order of each of the interaction operations. After the identification editing operation for at least one of the operation identifications is received through the interaction interface, the position of the operation identification may be adjusted based on the identification editing operation, so that the execution order of the multiple interaction operations is adjusted based on the positional relationship between the operation identifications. Optionally, displaying operation identifications corresponding to the multiple interaction operations in the interaction interface according to the execution order of each of the interaction operations includes: determining a display position of the operation identification corresponding to each interaction operation in the interaction interface according to the execution order of each of the interaction operations. Furthermore, multiple operation identifications may be displayed in the interaction interface according to the display position of each operation identification.

S120: Multiple first nodes are connected according to the execution order of the multiple interaction operations to obtain at least one directed operation graph.

The directed operation graph may be understood as a directed graph obtained by connecting multiple first nodes according to the execution order of the multiple interaction operations. In an embodiment of the present disclosure, the directed operation graph may be used to represent the execution order of the multiple interaction operations and the flow direction of the processing data. In an embodiment of the present disclosure, the directed operation graph may be a directed acyclic graph. In short, the directed operation graph may be a directed acyclic operation graph. In an embodiment of the present disclosure, in two connected first nodes in the directed operation graph, the processing data of the interaction operation corresponding to the subsequent first node includes at least part of the output data of the interaction operation corresponding to the previous first node. In an embodiment of the present disclosure, the data dependency relationship between the previous first node and the subsequent first node in the two connected first nodes may be intuitively and clearly reflected by the directed operation graph. Exemplarily, the two connected first nodes in the directed operation graph include a subsequent node B and a previous node A. Then, when the interaction operation corresponding to the node A is completed and the data is output, the data will be transmitted to the node B as part or all of the input data of the interaction operation corresponding to the node B.

Compared with organizing multiple interaction operations into a tree structure, in an embodiment of the present disclosure, the directed operation graph is constructed by connecting multiple first nodes according to the execution order of the multiple interaction operations, so that the execution order of the multiple interaction operations may be determined by the connection order of the first nodes in the directed operation graph. Multiple interaction operations are organized into a tree structure, and for an operation process with cross-dependence or parallel processing, the layer tree structure may not be able to intuitively and clearly display the execution order. Furthermore, once the tree structure is constructed, its structure is relatively fixed, and it is difficult to adapt to new interaction operations or changes in the execution order. The directed operation graph has higher flexibility and expandability, and nodes and directed edges may be easily added, deleted, or modified to adapt to changing business requirements.

Specifically, node connection information of the multiple first nodes is determined according to the execution order of the multiple interaction operations; and furthermore, the multiple first nodes may be connected according to the node connection information, to obtain the directed operation graph. It should be noted that the number of directed operation graphs obtained after the multiple first nodes are connected may be one or more. The node connection information may include each pair of nodes to be connected and a direction of an edge between the two nodes to be connected. In an embodiment of the present disclosure, data structures such as an adjacency matrix, an adjacency list, and a linked list may be used to store the nodes and connection relationships.

In an embodiment of the present disclosure, after obtaining at least one directed operation graph, the method may further include: displaying the directed operation graph in the interaction interface; and receiving a node editing operation for at least one of the operation nodes in the directed operation graph through the interaction interface, and updating the directed operation graph according to the node editing operation. In an embodiment of the present disclosure, the node editing operation for at least one of the operation nodes in the directed operation graph is supported through the interaction interface, so that the execution order of the interaction operations may be flexibly adjusted intuitively and conveniently.

The operation node may be understood as a node in the directed operation graph. The node editing operation may include at least a node position adjustment operation and/or a node deleting operation. The node position adjustment operation may be understood as an operation for adjusting a node position of the operation node in the directed operation graph. The node deleting operation may be understood as an operation for deleting the operation node in the directed operation graph.

Specifically, after multiple directed operation graphs are obtained, the multiple directed operation graphs may be displayed in the interaction interface. After a selection operation for the directed operation graphs is received through the interaction interface, the selected directed operation graph, that is, the directed operation graph to be edited, may be determined. After a selection operation for the operation node in the directed operation graph to be edited is received, the selected operation node is determined, and after the node editing operation for the selected operation node is received, the directed operation graph may be updated according to the node editing operation.

Exemplarily, the operation nodes in the directed operation graph may include a node A, a node B, and a node C. The node A is connected to the node B, the node B is connected to the node C, the node A points to the node B, and the node B points to the node C. After the node deleting operation for the node B is received, the connection between the node B and the node A and the connection between the node B and the node C are disconnected, the connection from the node A to the node C is established, and the node B is deleted. After the node position adjustment operation of adjusting the node B to a node position after the node C and adjacent to the node C is received, the connection between the node B and the node A and the connection between the node B and the node C are disconnected, and the connection from the node A to the node C and the connection between the node C and the node B are established.

S130: First processing logics corresponding to the multiple first nodes are executed according to the directed operation graph to obtain target media data, and display the target media data in the interaction interface.

The first processing logic may be understood as processing logic corresponding to the first node. In an embodiment of the present disclosure, the first processing logic is usually included in one or more classes and exists in the form of a method. These methods define specific behaviors of the node, such as data processing and business processing logic execution. In an embodiment of the present disclosure, the correspondence between the first node and the first processing logic may be one-to-one or one-to-many. In other words, one first node may correspond to one or more first processing logics. In the case that one node corresponds to multiple processing logics, an execution order of the multiple first processing logics may be determined based on a parameter transfer relationship between the multiple processing logics. The target media data may be understood as target media data that needs to be displayed and that is obtained according to the multiple interaction operations. The target media data may include at least one of image data, video data, and audio data. In an embodiment of the present disclosure, one or more of the target media data items may exist.

Specifically, the first processing logics corresponding to the multiple first nodes are executed based on the dependency relationship between the first nodes in the directed operation graph. After the multiple first processing logics are executed, the target media data may be obtained. After the target media data is obtained, the display position of the target media data in the interaction interface may be determined. Thus, the target media data may be displayed at the display position of the interaction interface.

Continuing with the above example, the operation nodes in the directed operation graph may include a node A, a node B, and a node C. The node A is connected to the node B, the node B is connected to the node C, the node A points to the node B, and the node B points to the node C. The first processing logic corresponding to the node A is processing logic A, the first processing logic corresponding to the node B is processing logic B, and the first processing logic corresponding to the node C is processing logic C. Then, executing the first processing logic corresponding to the node A, the node B, and the node C may specifically be executing the processing logic A first, then executing the processing logic B, and finally executing the processing logic C.

In an embodiment of the present disclosure, executing first processing logics corresponding to the multiple first nodes according to the directed operation graph may include: performing topological sorting on the directed operation graph to obtain a candidate topological sorting result of the directed operation graph; obtaining a target topological sorting result based on the candidate topological sorting result; and furthermore, executing the first processing logics corresponding to the multiple first nodes according to the target topological sorting result.

In an embodiment of the present disclosure, performing topological sorting on the directed operation graph may specifically include: determining a node with an in-degree of zero in the directed operation graph, taking the node with the in-degree of zero as an initial node, adding the initial node to a result sequence of the topological sorting, and deleting the node with the in-degree of zero and all edges emanated from the node with the in-degree of zero in the directed operation graph to update the directed operation graph; and when there is a node with an in-degree of zero in the updated directed operation graph, returning to the operation of determining a node with an in-degree of zero in the directed operation graph, taking the node with the in-degree of zero as an initial node, adding the initial node to a result sequence of the topological sorting, and deleting the node with the in-degree of zero and all edges emanated from the node with the in- degree of zero in the directed operation graph to update the directed operation graph, until there is no node with an in-degree of zero in the updated directed operation graph, and ending the topological sorting of the directed operation graph to obtain a topological sorting result of the directed operation graph.

In an embodiment of the present disclosure, obtaining a target topological sorting result based on the candidate topological sorting result may include: when the number of the candidate topological sorting result is one, determining the candidate topological sorting result as the target topological sorting result; and when the number of the candidate topological sorting results is multiple, selecting one topological sorting result from the multiple candidate topological sorting results as the target topological sorting result. In an embodiment of the present disclosure, there are multiple manners of selecting one topological sorting result from the multiple candidate topological sorting results. For example, one topological sorting result may be randomly selected from the multiple candidate topological sorting results. Alternatively, the first candidate topological sorting result may be taken as the target topological sorting result. Alternatively, the last candidate topological sorting result may be taken as the target topological sorting result.

In the technical solution of the embodiment of the present disclosure, multiple interaction operations are received through an interaction interface, an execution order of the multiple interaction operations and a first node corresponding to the interaction operation are determined, and the interaction interface is provided to facilitate the user to flexibly process media data through the multiple interaction operations, which enriches the processing manners of the media data. The execution order of the multiple interaction operations is determined to map the interaction manners into operation response logic, map the operation response logic into the first node, and achieve decoupling of the interaction operations and the processing logic by the first node. Furthermore, multiple first nodes are connected according to the execution order of the multiple interaction operations to obtain at least one directed operation graph, to clearly represent the response logic to the multiple interaction operations by the directed connection between the nodes in the directed operation graph. Moreover, the execution order of the multiple interaction operations may be indicated by the connection manner of the nodes in the directed operation graph. The first processing logics corresponding to the multiple first nodes is executed according to the directed operation graph to obtain the target media data, and the target media data is displayed in the interaction interface, the execution logic of the first processing logic may be determined by the connection manner of the first node, the first node is mapped to the first processing logic, and the target media data is obtained by executing the first processing logic, to achieve the quick response to the multiple interaction operations, solve the technical problem of code redundancy in the processing and development of media data by interaction operations in the related art, achieve decoupling of the interaction operations and the operation response logic by the nodes in the directed operation graph, simplify the interaction response manners, improve the reusability of the operation response logic, and further ensure the processing order of the interaction operations by the directed connection between the nodes in the directed operation graph, thus ensuring the accuracy and reliability of the interaction response, and improving the interface interaction experience.

FIG. 2 is a schematic flowchart of another interaction operation processing method according to an embodiment of the present disclosure. On the basis of the above embodiments, the technical solution of this embodiment further details the manner of executing first processing logics corresponding to multiple first nodes according to a directed operation graph to obtain target media data. Optionally, executing first processing logics corresponding to the multiple first nodes according to the directed operation graph to obtain target media data includes: determining a second node from the multiple first nodes in the directed operation graph, and executing a first processing logic corresponding to the second node to obtain the target media data, where the second node is an earliest executed first node in unexecuted first nodes. For specific implementations, reference may be made to the description of this embodiment. The technical features the same as or similar to those in the previous embodiments are not repeated herein. As shown in FIG. 2, the method of this embodiment may specifically include the following steps.

S210: Multiple interaction operations are received through an interaction interface, and an execution order of the multiple interaction operations and a first node corresponding to the interaction operation are determined.

S220: Multiple first nodes are connected according to the execution order of the multiple interaction operations to obtain at least one directed operation graph.

S230: A second node is determined from the multiple first nodes in the directed operation graph, a first processing logic corresponding to the second node is executed to obtain target media data, and the target media data is displayed in the interaction interface.

In an embodiment of the present disclosure, the second node is an earliest executed first node in unexecuted first nodes. It should be noted that the number of second nodes determined at a single time from the unexecuted first nodes may be one, two, or more than two. Specifically, the second node is determined from the multiple first nodes in the directed operation graph. Thus, the first processing logic corresponding to the second node may be executed. When the multiple first nodes in the directed operation graph are all executed, the target media data may be obtained. Furthermore, the target media data may be displayed in the interaction interface.

Continuing with the above example, the operation nodes in the directed operation graph may include a node A, a node B, and a node C. The node A is connected to the node B, the node B is connected to the node C, the node A points to the node B, and the node B points to the node C. When the node A is not executed, the first processing logic corresponding to the node A may be executed to process media data A to be processed corresponding to the directed operation, to obtain media data B. After the media data B is obtained, the media data to be processed in the interaction interface may be updated to the media data B. At this time, when the node A is already executed, the first processing logic corresponding to the node B may be executed to process the media data B to obtain media data C. After the media data C is obtained, the media data B in the interaction interface may be updated to the media data C. When the node B is executed, the first processing logic corresponding to the node C may be executed to process the media data C to obtain the media data C, that is, the target media data.

In an embodiment of the present disclosure, there are multiple manners of determining the second node from the multiple first nodes in the directed operation graph and executing the first processing logic corresponding to the second node. As an optional implementation of the embodiments of the present disclosure, determining the second node from the multiple first nodes in the directed operation graph and executing the first processing logic corresponding to the second node may include: when none of the first nodes in the directed operation graph is executed, taking a first node with an in-degree of zero in the directed operation graph as the second node. Thus, the first processing logic corresponding to the second node may be executed. When the first processing logic corresponding to the second node is executed, a preset identification is added to the second node and all edges emanated from the second node in the directed operation graph, to represent that the first processing logic corresponding to the second node is executed. Furthermore, a node with an in-degree of zero may be determined from first nodes to which the preset identification is not added in the directed operation graph, the node with the in-degree of zero is taken as the second node, and the operation of executing the first processing logic corresponding to the second node is returned. The preset identification may be set according to actual requirements and is not specifically limited herein.

As another optional implementation of the embodiments of the present disclosure, determining the second node from the multiple first nodes in the directed operation graph and executing the first processing logic corresponding to the second node may include: obtaining node states of the multiple first nodes in the directed operation graph, where the first node state is used to determine whether the first processing logic corresponding to the first node is executed; and determining multiple first nodes whose node state is an unexecuted state. A first executed first node, that is, the second node, in the multiple first nodes in the unexecuted state is determined based on a node dependency relationship between the multiple first nodes in the unexecuted state. Furthermore, the first processing logic corresponding to the second node may be executed.

Continuing with the above example, the operation nodes in the directed operation graph may include a node A, a node B, and a node C. The node A is connected to the node B, the node B is connected to the node C, the node A points to the node B, and the node B points to the node C. The operation nodes in the directed operation graph may further include a node D and a node E. The node C points to the node D, the node C points to the node E, and the node D points to the node E. Based on this, when the node A is not executed, it may be determined that the node A is the second node. When the first processing logic corresponding to the node A is executed, the node B may be taken as the second node. When the first processing logic corresponding to the node B is executed, the node C and the node D may be respectively taken as the second node. When both the first processing logic corresponding to the node C and the first processing logic corresponding to the node D are executed, the node E may be taken as the second node.

In the technical solution of the embodiment of the present disclosure, the second node is determined from the multiple first nodes in the directed operation graph, and the first processing logic corresponding to the second node is executed to obtain the target media data, to achieve the function of executing the first processing logic corresponding to the second node.

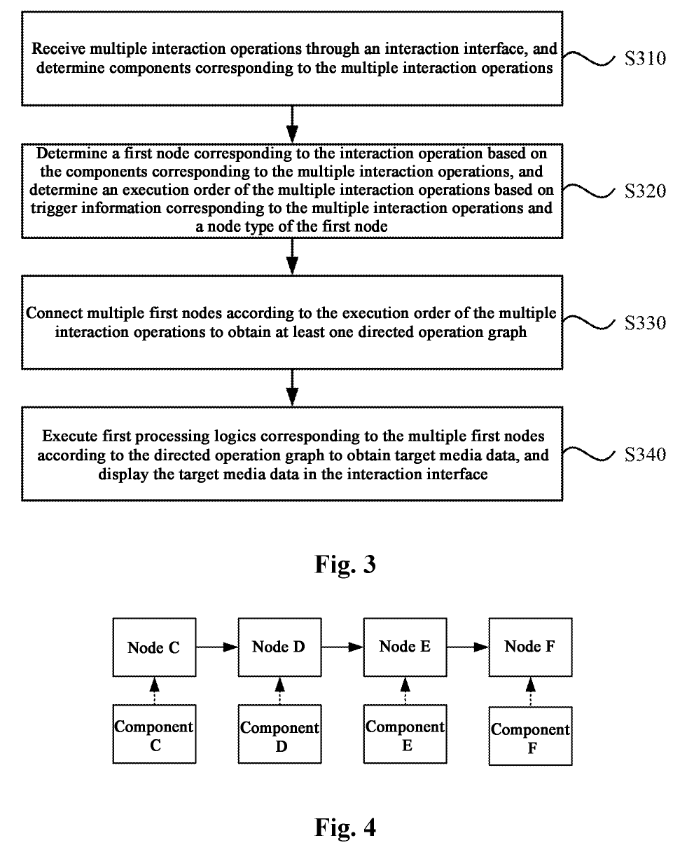

FIG. 3 is a schematic flowchart of another interaction operation processing method according to an embodiment of the present disclosure. On the basis of the above embodiments, the technical solution of this embodiment further details the manner of determining an execution order of multiple interaction operations and a first node corresponding to the interaction operation. Optionally, determining an execution order of the multiple interaction operations and a first node corresponding to the interaction operation includes: determining components corresponding to the multiple interaction operations, determining the first node corresponding to the interaction operation based on the components corresponding to the multiple interaction operations, and determining the execution order of the multiple interaction operations based on trigger information corresponding to the multiple interaction operations and a node type of the first node, where the trigger information includes a trigger time of the interaction operation and/or display information of an operation identification of the interaction operation in the interaction interface. For specific implementations, reference may be made to the description of this embodiment. The technical features the same as or similar to those in the previous embodiments are not repeated herein. As shown in FIG. 3, the method of this embodiment may specifically include the following steps.

S310: Multiple interaction operations are received through an interaction interface, and components corresponding to the multiple interaction operations are determined.

The component is encapsulated with a first processing logic. In an embodiment of the present disclosure, the first processing logic is encapsulated into the component to modularize the first processing logic, which may improve the reusability of the first processing logic. Specifically, after the multiple interaction operations are received through the interaction interface, for each interaction operation, the component corresponding to the interaction operation may be determined based on the correspondence between the interaction operation and the component. Thus, the components corresponding to the multiple interaction operations may be determined. It should be noted that when the first interaction operation is received, the first interaction operation may use a default component to represent that the interaction operation is the first interaction operation.

It should be noted that the correspondence between the interaction operation and the component may be one-to-one or one-to-many. In other words, one interaction operation may correspond to one or more components. Exemplarily, the interaction operations may include an interaction operation A and an interaction operation B. The interaction operation A corresponds to a component A, and the interaction operation A respectively corresponds to a component B and a component C. It should also be noted that the multiple interaction operations received through the interaction interface may be interaction operations acting on the same interactive element on the interaction interface at different times. Exemplarily, taking effect editing as an example, the effect editing interface may include a target control, and when the target control in the effect editing interface is continuously triggered multiple times, each trigger operation of the target control may be determined as a single interaction operation. The target control may be understood as a control used to add a layer in the effect editing interface.

S320: The first node corresponding to the interaction operation is determined based on the components corresponding to the multiple interaction operations, and the execution order of the multiple interaction operations is determined based on trigger information corresponding to the multiple interaction operations and a node type of the first node.

In an embodiment of the present disclosure, the correspondence between the component and the first node may be one-to-one or one-to-many. In other words, one component may correspond to one or more nodes. The trigger information may include a trigger time of the interaction operation and/or display information of an operation identification of the interaction operation in the interaction interface. The operation identification may be used to distinguish different interaction operations. In an embodiment of the present disclosure, the display information of the operation identification of the interaction operation in the interaction interface may include at least one of text information, image information, or audio information. The node type may include a first type, a second type, and a third type, the first type is a node type corresponding to a start node in the directed operation graph, the third type is a node type corresponding to an output node in the directed operation graph, and the second type is a node type connectable between the first node and the output node. In an embodiment of the present disclosure, nodes of different node types may have different execution logics and dependency relationships.

Specifically, after the components corresponding to the multiple interaction operations are determined, the components corresponding to the multiple interaction operations may be mapped to the first nodes corresponding to the components, that is, the first node corresponding to the interaction operation is obtained. After the first node corresponding to the interaction operation is obtained, the node type of the first node may be determined. Furthermore, the execution order of the multiple interaction operations may be determined based on the node type of the first node and the trigger information corresponding to the multiple interaction operations. In an embodiment of the present disclosure, determining the first node corresponding to the interaction operation based on the components corresponding to the multiple interaction operations may include: for each component corresponding to the multiple interaction operations, the component may be separately mapped to at least one first node, that is, the first node corresponding to the interaction operation is obtained.

In an embodiment of the present disclosure, there are multiple manners of determining the execution order of the multiple interaction operations based on the trigger information corresponding to the multiple interaction operations and the node type of the first node. For example, the execution order of the multiple interaction operations may be determined based on trigger times of the multiple interaction operations and the node type of the first node. Alternatively, the execution order of the multiple interaction operations may be determined based on display information of operation identifications of the multiple interaction operations in the interaction interface and the node type of the first node. Alternatively, the execution order of the multiple interaction operations may be determined based on trigger times of the multiple interaction operations, display information of operation identifications of the multiple interaction operations in the interaction interface, and the node type of the first node.

S330: The multiple first nodes are connected according to the execution order of the multiple interaction operations to obtain at least one directed operation graph.

Referring to FIG. 4, the multiple interaction operations may include an interaction operation C, an interaction operation D, an interaction operation E, and an interaction operation F, and the execution order of these interaction operations is: the interaction operation C, the interaction operation D, the interaction operation E, and the interaction operation F in sequence. The interaction operation C, the interaction operation D, the interaction operation E, and the interaction operation F respectively correspond to a component C, a component D, a component E, and a component F. Then, the component C may be mapped to a node C, the component D may be mapped to a node D, the component E may be mapped to a node E, and the component F may be mapped to a node F. Thus, based on the execution order of these interaction operations, the node C may be connected to the node D, the node D may be connected to the node E, and the node E may be connected to the node F, where the node C points to the node D, the node D points to the node E, and the node E points to the node F.

S340: First processing logics corresponding to the multiple first nodes are executed according to the directed operation graph to obtain target media data, and display the target media data in the interaction interface.

Specifically, a dependency relationship between the multiple first nodes in the directed operation graph is determined. The first processing logic encapsulated in the component corresponding to the first node is executed according to the dependency relationship to obtain the target media data.

In the technical solution of the embodiment of the present disclosure, the components corresponding to the multiple interaction operations are determined, and the execution order of the multiple interaction operations is determined based on the trigger information corresponding to the multiple interaction operations and the node type of the first node corresponding to the component, where the trigger information includes the trigger time of the interaction operation and/or the display information of the operation identification of the interaction operation in the interaction interface, to achieve the function of determining the execution order of the multiple interaction operations.

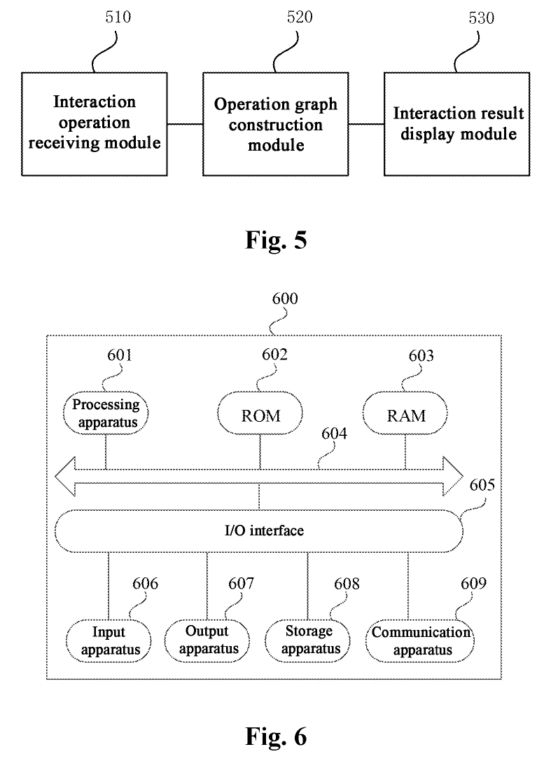

FIG. 5 is a schematic structural diagram of an interaction operation processing apparatus according to an embodiment of the present disclosure. As shown in FIG. 5, the apparatus includes an interaction operation receiving module 510, an operation graph construction module 520, and an interaction result display module 530. The interaction operation receiving module 510 is configured to receive multiple interaction operations through an interaction interface, and determine an execution order of the multiple interaction operations and a first node corresponding to the interaction operation; the operation graph construction module 520 is configured to connect multiple first nodes according to the execution order of the multiple interaction operations to obtain at least one directed operation graph; and the interaction result display module 530 is configured to execute first processing logics corresponding to the multiple first nodes according to the directed operation graph to obtain target media data, and display the target media data in the interaction interface.

In the technical solution of the embodiment of the present disclosure, the interaction operation receiving module 510 receives multiple interaction operations through an interaction interface, and determines an execution order of the multiple interaction operations and a first node corresponding to the interaction operation, the interaction interface is provided to facilitate the user to flexibly process media data through the multiple interaction operations, which enriches the processing manners of the media data. The execution order of the multiple interaction operations is determined to map the interaction manners into operation response logic, map the operation response logic into the first node, and achieve decoupling of the interaction operations and the processing logic by the first node. Furthermore, the operation graph construction module 520 connects multiple first nodes according to the execution order of the multiple interaction operations to obtain at least one directed operation graph, to clearly represent the response logic to the multiple interaction operations by the directed connection between the nodes in the directed operation graph. Moreover, the execution order of the multiple interaction operations may be indicated by the connection manner of the nodes in the directed operation graph. The interaction result display module 530 executes the first processing logics corresponding to the multiple first nodes according to the directed operation graph to obtain the target media data, and displays the target media data in the interaction interface, the execution logic of the first processing logic may be determined by the connection manner of the first node, the first node is mapped to the first processing logic, and the target media data is obtained by executing the first processing logic, to achieve the quick response to the multiple interaction operations, solve the technical problem of code redundancy in the processing and development of media data by interaction operations in the related art, achieve decoupling of the interaction operations and the operation response logic by the nodes in the directed operation graph, simplify the interaction response manners, improve the reusability of the operation response logic, and further ensure the processing order of the interaction operations by the directed connection between the nodes in the directed operation graph, thus ensuring the accuracy and reliability of the interaction response, and improving the interface interaction experience.

On the basis of any optional technical solution in the embodiment of the present disclosure, optionally, in two connected first nodes in the directed operation graph, the processing data of the interaction operation corresponding to the subsequent first node includes at least part of the output data of the interaction operation corresponding to the previous first node.

On the basis of any optional technical solution in the embodiment of the present disclosure, optionally, the interaction result display module 530 is configured to determine a second node from the multiple first nodes in the directed operation graph, and execute a first processing logic corresponding to the second node to obtain the target media data, where the second node is the first node that is earliest to be executed among the unexecuted first nodes.

On the basis of any optional technical solution in the embodiment of the present disclosure, optionally, the interaction operation receiving module 510 is configured to determine components corresponding to the multiple interaction operations, determine the first node corresponding to the interaction operation based on the components corresponding to the multiple interaction operations, and determine the execution order of the multiple interaction operations based on trigger information corresponding to the multiple interaction operations and a node type of the first node, where the trigger information includes a trigger time of the interaction operation and/or display information of an operation identification of the interaction operation in the interaction interface.

On the basis of any optional technical solution in the embodiment of the present disclosure, optionally, the interaction operation receiving module 510 is configured to display multiple controls in the interaction interface, and receive an interaction operation for at least one of the controls through the interaction interface, where a response event of the control is associated with a pre-built component, and the component is encapsulated with a second processing logic.

On the basis of any optional technical solution in the embodiment of the present disclosure, optionally, the apparatus further includes an execution order updating module, the execution order updating module is configured to display, after the execution order of each of the interaction operations is determined, operation identifications corresponding to the multiple interaction operations in the interaction interface according to the execution order of each of the interaction operations, and receive an identification editing operation for at least one of the operation identifications through the interaction interface, and update the execution order of the multiple interaction operations according to the identification editing operation, where the identification editing operation includes at least one of an identification position adjustment operation, an identification adding operation, and an identification deleting operation.

On the basis of any optional technical solution in the embodiment of the present disclosure, optionally, the apparatus further includes a directed operation graph updating module, where the directed operation graph updating module is configured to display, after at least one directed operation graph is obtained, the directed operation graph in the interaction interface, and receive a node editing operation for at least one operation node in the directed operation graph through the interaction interface, and update the directed operation graph according to the node editing operation, where the node editing operation includes at least a node position adjustment operation and/or a node deleting operation.

On the basis of any optional technical solution in the embodiment of the present disclosure, optionally, the interaction interface includes an effect editing interface and/or a template editing interface, the effect editing interface includes an interface for editing an effect file and/or an interface for editing media content by applying the effect file, the template editing interface is used to edit an interface that may be used to edit a template file, and the template file includes a data slot for setting media content and preset processing logic corresponding to the media content.

The interaction operation processing apparatus provided by the embodiment of the present disclosure may perform the interaction operation processing method provided by any embodiment of the present disclosure, and has corresponding functional modules and beneficial effects for performing the interaction operation processing method.

It is worth noting that the units and modules included in the above apparatus are only divided according to functional logic, but are not limited to the above division, as long as the corresponding functions may be achieved. Furthermore, the specific names of the functional units are only for the convenience of distinguishing from each other, and are not used to limit the protection scope of the embodiments of the present disclosure.

Reference is made to FIG. 6 below, which illustrates a schematic structural diagram of an electronic device (e.g., a terminal device or a server) 600 suitable for implementing an embodiment of the present disclosure. The terminal device in the embodiment of the present disclosure may include, but is not limited to, mobile terminals such as a mobile phone, a laptop, a digital broadcast receiver, a PDA (personal digital assistant), a PAD (tablet computer), a PMP (portable multimedia player), a vehicle-mounted terminal (e.g., a vehicle navigation terminal), etc., and fixed terminals such as a digital TV, a desktop computer, etc. The electronic device shown in FIG. 6 is only an example, and should not impose any limitation on the function and scope of use of the embodiment of the present disclosure.

As shown in FIG. 6, the electronic device 600 may include a processing apparatus (e.g., a central processing unit, a graphics processing unit, etc.) 601, which may perform various appropriate actions and processes according to a program stored in a read-only memory (ROM) 602 or a program loaded from a storage apparatus 608 into a random access memory (RAM) 603. The RAM 603 further stores various programs and data required for operations of the electronic device 600. The processing apparatus 601, the ROM 602, and the RAM 603 are connected to each other through a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or provide all of the shown apparatuses. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program codes for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiment of the present disclosure are executed.

The names of messages or information exchanged between multiple apparatuses in the implementations of the present disclosure are only for illustrative purposes, and are not intended to limit the scope of these messages or information.

The electronic device provided by the embodiment of the present disclosure belongs to the same inventive concept as the interaction operation processing method provided by the above-mentioned embodiment. For technical details not described in detail in the embodiment of the present disclosure, reference may be made to the above-mentioned embodiment, and the present embodiment has the same beneficial effects as the above-mentioned embodiment.

An embodiment of the present disclosure provides a computer storage medium having a computer program stored thereon, and when the program is executed by a processor, the interaction operation processing method provided by the above-mentioned embodiments is implemented.

It should be noted that the above-mentioned computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semi-conductive system, apparatus, device, or any combination of the above. More specific examples of the computer-readable storage medium may include, but are not limited to: an electrically connected portable computer magnetic disk having one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus, or device. In the present disclosure, the computer-readable signal medium may include a data signal propagated in a baseband or as a part of a carrier wave, and computer-readable program codes are carried therein. This propagated data signal may take many forms, including but not limited to electromagnetic signals, optical signals, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program codes contained on the computer-readable medium may be transmitted by any suitable medium, including but not limited to wires, optical cables, RF (radio frequency), etc., or any suitable combination of the above.

According to one or more embodiments of the present disclosure, [Example 1] provides an interaction operation processing method, including:

receiving multiple interaction operations through an interaction interface, and determining an execution order of the multiple interaction operations and a first node corresponding to the interaction operation; connecting multiple first nodes according to the execution order of the multiple interaction operations to obtain at least one directed operation graph; and executing first processing logics corresponding to the multiple first nodes according to the directed operation graph to obtain target media data, and displaying the target media data in the interaction interface.

According to one or more embodiments of the present disclosure, [Example 2] provides the method of Example 1, further including: optionally,

in two connected first nodes in the directed operation graph, the processing data of the interaction operation corresponding to the subsequent first node includes at least part of the output data of the interaction operation corresponding to the previous first node.

According to one or more embodiments of the present disclosure, [Example 3] provides the method of Example 1, further including: optionally,

executing first processing logics corresponding to the multiple first nodes according to the directed operation graph to obtain target media data includes: determining a second node from the multiple first nodes in the directed operation graph, and executing a first processing logic corresponding to the second node to obtain the target media data, where the second node is the first node that is earliest to be executed among the unexecuted first nodes.

According to one or more embodiments of the present disclosure, [Example 4] provides the method of Example 1, further including: optionally,

determining an execution order of the multiple interaction operations and a first node corresponding to the interaction operation includes: determining components corresponding to the multiple interaction operations, determining the first node corresponding to the interaction operation based on the components corresponding to the multiple interaction operations, and determining the execution order of the multiple interaction operations based on trigger information corresponding to the multiple interaction operations and a node type of the first node, where the trigger information includes a trigger time of the interaction operation and/or display information of an operation identification of the interaction operation in the interaction interface.

According to one or more embodiments of the present disclosure, [Example 5] provides the method of Example 1, further including: optionally,

receiving multiple interaction operations through an interaction interface includes: displaying multiple controls in the interaction interface, and receiving an interaction operation for at least one of the controls through the interaction interface, where a response event of the control is associated with a pre-built component, and the component is encapsulated with a second processing logic.

According to one or more embodiments of the present disclosure, [Example 6] provides the method of Example 1, further including: optionally,

after the execution order of each of the interaction operations is determined, the method further includes: displaying operation identifications corresponding to the multiple interaction operations in the interaction interface according to the execution order of each of the interaction operations, and receiving an identification editing operation for at least one of the operation identifications through the interaction interface, and updating the execution order of the multiple interaction operations according to the identification editing operation, where the identification editing operation includes at least one of an identification position adjustment operation, an identification adding operation, and an identification deleting operation.

According to one or more embodiments of the present disclosure, [Example 7] provides the method of Example 1, further including: optionally,

after at least one directed operation graph is obtained, the method further includes: displaying the directed operation graph in the interaction interface, and receiving a node editing operation for at least one operation node in the directed operation graph through the interaction interface, and updating the directed operation graph according to the node editing operation, where the node editing operation includes at least a node position adjustment operation and/or a node deleting operation.

According to one or more embodiments of the present disclosure, [Example 8] provides the method of Example 1, further including: optionally, the interaction interface includes an effect editing interface and/or a template editing interface, the effect editing interface includes an interface for editing an effect file and/or an interface for editing media content by applying the effect file, the template editing interface is used to edit an interface that may be used to edit a template file, and the template file includes a data slot for setting media content and preset processing logic corresponding to the media content.

According to one or more embodiments of the present disclosure, [Example 9] provides an interaction operation processing apparatus, including:

an interaction operation receiving module configured to receive multiple interaction operations through an interaction interface, and determine an execution order of the multiple interaction operations and a first node corresponding to the interaction operation; an operation graph construction module configured to connect multiple first nodes according to the execution order of the multiple interaction operations to obtain at least one directed operation graph; and an interaction result display module configured to execute first processing logics corresponding to the multiple first nodes according to the directed operation graph to obtain target media data, and display the target media data in the interaction interface.

In some implementations, the client and the server may communicate using any currently known or future developed network protocol, such as the HTTP (HyperText Transfer Protocol), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The above-mentioned computer-readable medium may be included in the above-mentioned electronic device, or may exist alone without being assembled into the electronic device.

The above-mentioned computer-readable medium carries one or more programs, and when the one or more programs are executed by the electronic device, the electronic device: receives multiple interaction operations through an interaction interface, and determines an execution order of the multiple interaction operations and a first node corresponding to the interaction operation; connects multiple first nodes according to the execution order of the multiple interaction operations to obtain at least one directed operation graph; and executes first processing logics corresponding to the multiple first nodes according to the directed operation graph to obtain target media data, and displays the target media data in the interaction interface.

The computer program codes for performing the operations of the present disclosure may be written in one or more programming languages or a combination thereof, where the programming languages include, but are not limited to, an object-oriented programming language, such as Java, Smalltalk, and C++, and further include conventional procedural programming languages, such as "C" language or similar programming languages. The program codes may be executed entirely on a user computer, partly on the user computer, as a stand-alone software package, partly on the user computer and partly on a remote computer, or entirely on the remote computer or server. In the case of involving the remote computer, the remote computer may be connected to the user computer through any kind of network, including a local area network (LAN) or a wide area network (WAN), or may be connected to an external computer (for example, connected through the Internet with the aid of an Internet service provider).

The flowchart and block diagrams in the drawings illustrate the architecture, functionality, and operation of possible implementations of systems, methods and computer program products according to various embodiments of the present disclosure. In this regard, each block in the flowchart or block diagrams may represent a module, program segment, or portion of code, which includes one or more executable instructions for implementing the specified logical functions. It should also be noted that, in some alternative implementations, the functions noted in the block may occur in an order different from that noted in the drawings. For example, two blocks shown in succession may, in fact, be executed substantially concurrently, or the blocks may sometimes be executed in a reverse order, depending upon the functionality involved. It will also be noted that each block of the block diagrams and/or flowchart, and combinations of blocks in the block diagrams and/or flowchart, may be implemented by dedicated hardware-based systems that perform the specified functions or operations, or combinations of dedicated hardware and computer instructions.

The involved units described in the embodiments of the present disclosure may be implemented by software or hardware. The name of a unit does not constitute a limitation on the unit itself under certain circumstances, for example, the operation graph construction module may also be described as "a module that connects multiple first nodes according to an execution order of multiple interaction operations to obtain at least one directed operation graph".

The functions described above may be performed at least in part by one or more hardware logic components. For example, non-restrictively, exemplary types of hardware logic components that may be used include: field programmable gate array (FPGA), application specific integrated circuit (ASIC), application specific standard product (ASSP), system on chip (SOC), complex programmable logic device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium includes, but is not limited to, an electronic, magnetic, optical, electromagnetic, infrared, or semi-conductive system, apparatus, or device, or any suitable combination of the above. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an illustration of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalent features. For example, a technical solution formed by replacing the above features with technical features with similar functions disclosed in the present disclosure (but not limited to).

Furthermore, although the various operations are depicted in a particular order, this should not be understood as requiring that the operations be performed in the particular order shown or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are merely example forms for implementing the claims.

1. An interaction operation processing method, comprising:
receiving multiple interaction operations through an interaction interface, and determining an execution order of the multiple interaction operations and a first node corresponding to the interaction operation;
connecting multiple first nodes based on the execution order of the multiple interaction operations to obtain at least one directed operation graph; and
executing first processing logics corresponding to the multiple first nodes based on the directed operation graph to obtain target media data, and displaying the target media data in the interaction interface.

2. The interaction operation processing method of claim 1, wherein, in the directed operation graph, for in two connected first nodes, processing data of an interaction operation corresponding to a subsequent first node comprises at least part of output data of an interaction operation corresponding to a previous first node.

3. The interaction operation processing method of claim 1, wherein executing the first processing logics corresponding to the multiple first nodes based on the directed operation graph to obtain the target media data comprises:
determining a second node from the multiple first nodes in the directed operation graph, and executing a first processing logic corresponding to the second node to obtain the target media data, wherein the second node is a first node that is earliest to be executed among the unexecuted first nodes.

4. The interaction operation processing method of claim 1, wherein determining the execution order of the multiple interaction operations and the first node corresponding to the interaction operation comprises:
determining components corresponding to the multiple interaction operations, determining the first node corresponding to the interaction operation based on the components corresponding to the multiple interaction operations, and determining the execution order of the multiple interaction operations based on trigger information corresponding to the multiple interaction operations and a node type of the first node, wherein the trigger information comprises a trigger time of the interaction operation and/or display information of an operation identification of the interaction operation in the interaction interface.

5. The interaction operation processing method of claim 1, wherein receiving the multiple interaction operations through the interaction interface comprises:
displaying multiple controls in the interaction interface, and receiving an interaction operation for at least one of the controls through the interaction interface, wherein a response event of the control is associated with a pre-built component, and the component is encapsulated with a second processing logic.

6. The interaction operation processing method of claim 1, wherein after an execution order of each of the interaction operations is determined, the method further comprises:
displaying operation identifications corresponding to the multiple interaction operations in the interaction interface based on the execution order of each of the interaction operations; and
receiving an identification editing operation for at least one of the operation identifications through the interaction interface, and updating the execution order of the multiple interaction operations based on the identification editing operation, wherein the identification editing operation comprises at least one of an identification position adjustment operation, an identification adding operation, and an identification deleting operation.

7. The interaction operation processing method of claim 1, wherein after at least one directed operation graph is obtained, the method further comprises:
displaying the directed operation graph in the interaction interface; and
receiving a node editing operation for at least one operation node in the directed operation graph through the interaction interface, and updating the directed operation graph based on the node editing operation, wherein the node editing operation comprises at least a node position adjustment operation and/or a node deleting operation.

8. The interaction operation processing method of claim 1, wherein the interaction interface comprises an effect editing interface and/or a template editing interface, the effect editing interface comprises an interface for editing an effect file and/or an interface for editing media content by applying the effect file, the template editing interface is configured to edit an interface for editing a template file, and the template file comprises a data slot for setting the media content and preset processing logic corresponding to the media content.

9. An electronic device, comprising:
one or more processors,
a memory configured to store one or more programs that,
when executed by the one or more processors, cause the one or more processors to:
receive multiple interaction operations through an interaction interface, and determine an execution order of the multiple interaction operations and a first node corresponding to the interaction operation;
connect multiple first nodes based on the execution order of the multiple interaction operations to obtain at least one directed operation graph; and
execute first processing logics corresponding to the multiple first nodes based on the directed operation graph to obtain target media data, and display the target media data in the interaction interface.

10. The electronic device of claim 9, wherein, in the directed operation graph, for in two connected first nodes, processing data of an interaction operation corresponding to a subsequent first node comprises at least part of output data of an interaction operation corresponding to a previous first node.

11. The electronic device of claim 9, wherein the one or more programs causing the one or more processors to execute the first processing logics corresponding to the multiple first nodes based on the directed operation graph to obtain the target media data further cause the one or more processors to:
determine a second node from the multiple first nodes in the directed operation graph, and execute a first processing logic corresponding to the second node to obtain the target media data, wherein the second node is a first node that is earliest to be executed among the unexecuted first nodes.

12. The electronic device of claim 9, wherein the one or more programs causing the one or more processors to determine the execution order of the multiple interaction operations and the first node corresponding to the interaction operation further cause the one or more processors to:
determine components corresponding to the multiple interaction operations, determine the first node corresponding to the interaction operation based on the components corresponding to the multiple interaction operations, and determine the execution order of the multiple interaction operations based on trigger information corresponding to the multiple interaction operations and a node type of the first node, wherein the trigger information comprises a trigger time of the interaction operation and/or display information of an operation identification of the interaction operation in the interaction interface.

13. The electronic device of claim 9, wherein the one or more programs causing the one or more processors to receive the multiple interaction operations through the interaction interface further cause the one or more processors to:
display multiple controls in the interaction interface, and receive an interaction operation for at least one of the controls through the interaction interface, wherein a response event of the control is associated with a pre-built component, and the component is encapsulated with a second processing logic.

14. The electronic device of claim 9, wherein after an execution order of each of the interaction operations is determined, the one or more programs further cause the one or more processors to:
display operation identifications corresponding to the multiple interaction operations in the interaction interface based on the execution order of each of the interaction operations; and
receive an identification editing operation for at least one of the operation identifications through the interaction interface, and update the execution order of the multiple interaction operations based on the identification editing operation, wherein the identification editing operation comprises at least one of an identification position adjustment operation, an identification adding operation, and an identification deleting operation.

15. The electronic device of claim 9, wherein after at least one directed operation graph is obtained, the one or more programs further cause the one or more processors to:
display the directed operation graph in the interaction interface; and
receive a node editing operation for at least one operation node in the directed operation graph through the interaction interface, and update the directed operation graph based on the node editing operation, wherein the node editing operation comprises at least a node position adjustment operation and/or a node deleting operation.

16. The electronic device of claim 9, wherein the interaction interface comprises an effect editing interface and/or a template editing interface, the effect editing interface comprises an interface for editing an effect file and/or an interface for editing media content by applying the effect file, the template editing interface is configured to edit an interface for editing a template file, and the template file comprises a data slot for setting the media content and preset processing logic corresponding to the media content.

17. A non-transitory storage medium comprising computer-executable instructions that, when executed by a computer processor, cause the computer processor to:
receive multiple interaction operations through an interaction interface, and determine an execution order of the multiple interaction operations and a first node corresponding to the interaction operation;
connect multiple first nodes based on the execution order of the multiple interaction operations to obtain at least one directed operation graph; and
execute first processing logics corresponding to the multiple first nodes based on the directed operation graph to obtain target media data, and display the target media data in the interaction interface.

18. The non-transitory storage medium of claim 17, wherein, in the directed operation graph, for in two connected first nodes, processing data of an interaction operation corresponding to a subsequent first node comprises at least part of output data of an interaction operation corresponding to a previous first node.

19. The non-transitory storage medium of claim 17, wherein the computer-executable instructions to execute the first processing logics corresponding to the multiple first nodes based on the directed operation graph to obtain the target media data comprise instructions to:
determine a second node from the multiple first nodes in the directed operation graph, and execute a first processing logic corresponding to the second node to obtain the target media data, wherein the second node is a first node that is earliest to be executed among the unexecuted first nodes.

20. The non-transitory storage medium of claim 17, wherein the computer-executable instructions to determine the execution order of the multiple interaction operations and the first node corresponding to the interaction operation comprise instructions to:
determine components corresponding to the multiple interaction operations, determine the first node corresponding to the interaction operation based on the components corresponding to the multiple interaction operations, and determine the execution order of the multiple interaction operations based on trigger information corresponding to the multiple interaction operations and a node type of the first node, wherein the trigger information comprises a trigger time of the interaction operation and/or display information of an operation identification of the interaction operation in the interaction interface.
